(19) United States
(12) Patent Application Publication
(10) Pub. No.: US 2023/0372752 A1
(43) Pub. Date: Nov. 23, 2023

(54) FIREFIGHTING SYSTEM

(71) Applicant: Firebrand Development Inc., Harper Woods, MI (US)

(72) Inventor: Leonard Davis, Harper Woods, MI (US)

(73) Assignee: Firebrand Development Inc., Harper Woods, MI (US)

(21) Appl. No.: 17/746,513

(22) Filed: May 17, 2022

(51) Int. Cl. A62C 3/02

(52) U.S. Cl. CPC A62C 3/0264

(57) ABSTRACT

A fluid discharge cap for a firefighting apparatus includes a body and a plurality of ports. The body is configured to be removably secured to the firefighting apparatus and includes a flange portion and a face portion. The flange portion extends around a periphery of the face portion and is removably secured to the firefighting apparatus. The plurality of ports are formed in at least a portion of the face portion of the body. Pressurized fluid flowing through the firefighting apparatus exits the ports in a predetermined direction.

### FIELD

The present disclosure relates to a firefighting system and a firefighting system comprising a fluid discharge cap.

### BACKGROUND

The statements in this section merely provide background information related to the present disclosure and may not constitute prior art.

Conventional firefighting systems are not well equipped to handle fires in remote areas (e.g., wildland setting) due in part to the lack of water sources in such areas. Furthermore, conventional firefighting systems are not adaptable to provide for fire protection against a variety of fire types in such remote areas. As such, it is often difficult for firefighters to inhibit the spread of fires in these remote areas, which results in fires in such settings being responsible for millions of dollars in damage every year.

These issues related to fire protection in remote areas, among other issues relates to fire protection in remote areas, are addressed by the present disclosure.

### SUMMARY

This section provides a general summary of the disclosure and is not a comprehensive disclosure of its full scope or all of its features.

In one form, the present disclosure provides a fluid discharge cap for a firefighting apparatus. The fluid discharge cap includes a body and a plurality of ports. The body is configured to be removably secured to the firefighting apparatus and includes a flange portion and a face portion. The flange portion extends around a periphery of the face portion and is removably secured to the firefighting apparatus. The plurality of ports are formed in at least a portion of the face portion of the body. Pressurized fluid flowing through the firefighting apparatus exits the ports in a predetermined direction.

In variations of the fluid discharge cap of the above paragraph, which may be implemented individually or in any combination: a cap detachment member is fixed to the face portion of the body, the cap detachment member is configured to facilitate securement of the body onto the firefighting apparatus and facilitate removal of the body from the firefighting apparatus; the cap detachment member has a pentagonal shape; a cap alignment feature is associated with the face portion of the body and is configured to provide alignment of the body onto the firefighting apparatus; the face portion has a wedge shape or a dome shape; and the ports are configured to direct the pressurized fluid in a vertical direction.

In another form, the present disclosure provides a firefighting system comprising a first firefighting apparatus. The first firefighting apparatus comprises a receptacle and a fluid discharge cap. The receptacle includes an inlet, a first outlet and a second outlet. The fluid discharge cap is removably secured to the receptacle and covers the second outlet. The fluid discharge cap comprises a body comprising a flange portion, a face portion and a plurality of ports. The flange portion extends around a periphery of the face portion. The plurality of ports are formed in at least a portion of the face portion of the body. Pressurized fluid flowing through the receptacle exits the ports in a predetermined direction.

In variations of the firefighting system of the above paragraph, which may be implemented individually or in any combination: the receptacle incudes a first connecting member located at the inlet of the receptacle and a second connecting member located at the first outlet of the receptacle; a second firefighting apparatus is fluidly connected to the first firefighting apparatus via the first connecting member or the second connecting member; a valve is associated with the inlet and moveable between a first position in which pressurized fluid is allowed to flow through the receptacle and a second position in which pressurized fluid is inhibited from flowing through the receptacle; the second outlet has a fluid flow area that is greater than the fluid flow areas of the inlet and the first outlet; the ports are configured to direct the pressurized fluid in multiple directions; the fluid discharge cap comprises a cap alignment feature associated with the face portion of the body and configured to provide alignment of the fluid discharge cap onto the receptacle; the face portion has a wedge shape or a dome shape; and the first firefighting apparatus is portable.

In yet another form, the present disclosure provides a firefighting system comprising a plurality of firefighting apparatuses connected in series. Each of the firefighting apparatuses comprises a receptacle and a fluid discharge cap. The receptacle includes an inlet, a first outlet and a second outlet. The fluid discharge cap is removably secured to the receptacle and covers the second outlet. The fluid discharge cap comprises a body comprising a flange portion, a face portion and a plurality of ports. The flange portion extends around a periphery of the face portion. The plurality of ports are formed in at least a portion of the face portion of the body. Pressurized fluid flowing through the receptacle exits the ports and forms a fluid curtain.

In variations of the firefighting system of the above paragraph, which may be implemented individually or in any combination: each of the firefighting apparatuses are self-supporting; the plurality of firefighting apparatuses are portable; the plurality of firefighting apparatuses are connected in series via flexible conduits; and the ports of the plurality of firefighting apparatuses are configured to direct the pressurized fluid in multiple directions.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a firefighting system according to the principles of the present disclosure;

FIG. 2 is another schematic view of the firefighting system of FIG. 1 forming a fluid curtain;

FIG. 3a is a front view of one firefighting apparatus of the firefighting system of FIG. 1 comprising a fluid discharge cap secured to a receptacle of the firefighting apparatus;

FIG. 3b is a front view of one firefighting apparatus of the firefighting system of FIG. 1 comprising the fluid discharge cap removed from the receptacle;

FIG. 4 is a side view of the firefighting apparatus of the firefighting system of FIG. 1;

FIG. 5 is another side view of the firefighting apparatus of the firefighting system of FIG. 1 with the fluid discharge cap removed from the receptacle of the firefighting apparatus;

FIG. 6 is a top view of the firefighting apparatus of the firefighting system of FIG. 1;

FIG. 7a is a front view of the fluid discharge cap of the firefighting apparatus of the firefighting system of FIG. 1;

FIG. 7b is a side view of the fluid discharge cap of the firefighting apparatus of the firefighting system of FIG. 1;

FIG. 8 is a side view of the firefighting apparatus of the firefighting system of FIG. 1 with pressurized fluid exiting the fluid discharge cap;

FIG. 9 is a front view of the firefighting apparatus of the firefighting system of FIG. 1 with pressurized fluid exiting the fluid discharge cap;

FIG. 10 is a front view of an alternate fluid discharge cap according to the principles of the present disclosure;

FIG. 11 is a side view of the fluid discharge cap of FIG. 10; and

FIG. 12 is a front view of another firefighting apparatus according to the principles of the present disclosure comprising the fluid discharge cap of FIG. 10.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

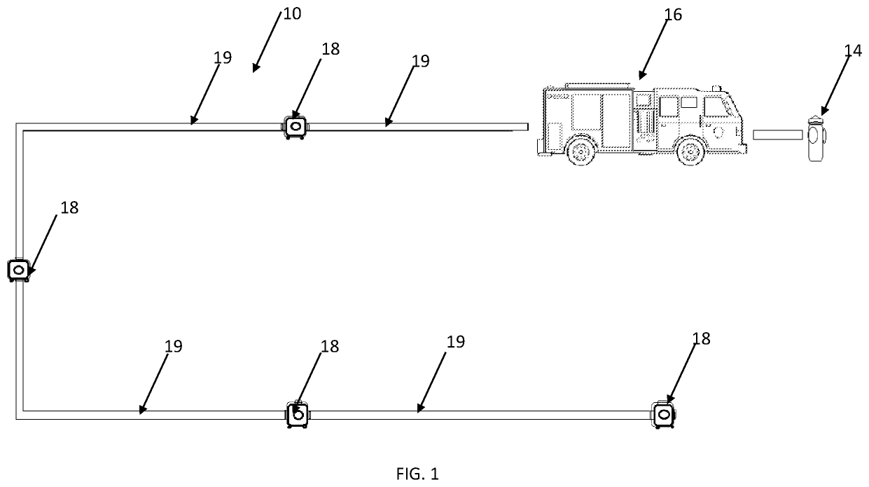

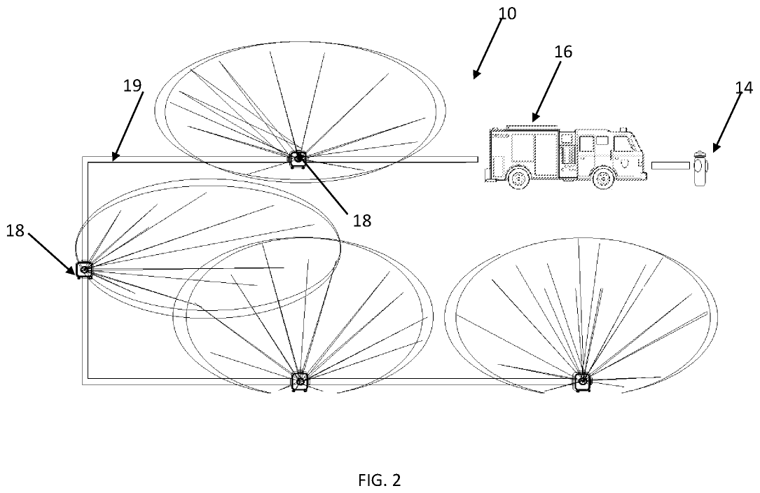

With reference to FIGS. 1 and 2, a firefighting system 10 is illustrated. In one example, the firefighting system 10 is configured to form a fluid curtain (FIG. 2), thereby providing fire containment, for example, without blocking the movement of persons in the area. In another example, the firefighting system 10 is configured to direct pressurized fluid such as water at a combustion source or an area that comprises a fire to extinguish the fire. The firefighting system 10 is fluidly connected to a fluid source 14 and a pumping device 16 (e.g., a firetruck). In this way, fluid from the fluid source 14 is directed to the pumping device 16 where the fluid is pressurized. The pressurized fluid then flows from the pumping device 16 to the firefighting system 10 where it is directed toward the area that comprises the fire. In the example illustrated, the fluid source 14 is a fire hydrant. In another example, the fluid source 14 is a pond, lake, or river, for example. In another example, the fluid source 14 may be contained in the pumping device 16. That is, fluid contained in the pumping device 16 is pressurized prior to flowing to the firefighting system 10 where it is directed toward the area that comprises the fire.

The firefighting system 10 comprises a plurality of firefighting apparatuses 18 connected in series via a plurality of flexible conduits 19. In this way, the firefighting system 10 can conveniently be arranged around the area comprising the fire. Each firefighting apparatus 18 is portable. Each firefighting apparatus 18 is a stand-alone unit operable to form a water curtain.

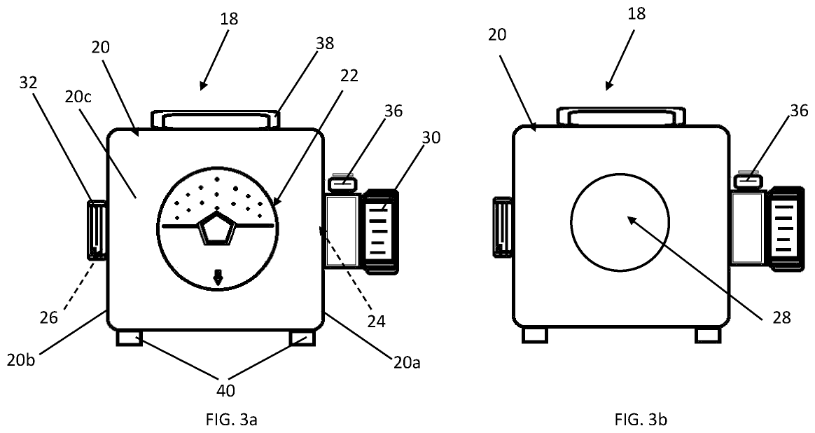

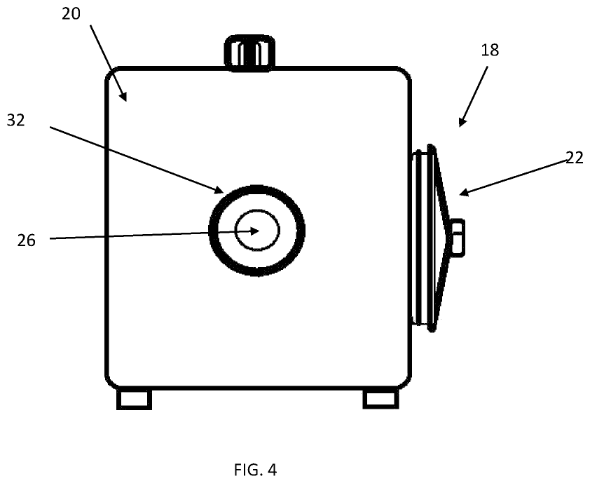

With additional reference to FIGS. 3a-9, each firefighting apparatus 18 includes a receptacle or pod 20 (FIGS. 3a-6, 9 and 10) and a fluid discharge cap 22 (FIGS. 3a and 4-9). In one form, the firefighting apparatus 18 is made of a non-conductive material such as fiberglass or rubber, for example. In the example illustrated, the receptacle 20 includes a generally cubic shape. In other configurations, the receptacle 20 may be other suitable shapes such as a triangular prism or cuboid, for example. The receptacle 20 is disposed on a ground surface such that the receptacle 20 is self-supporting (i.e., does not need support from connecting lines or separate devices to support the receptacle 20). The receptacle 20 includes an inlet 24, a first outlet 26, and a second outlet 28 (FIG. 3b). The inlet 24 is located at a first planar side 20a of the receptacle 20 and the first outlet 26 is located at a second planar side 20b of the receptacle 20 that is opposite the first planar side 20a. The second outlet 28 is located at a third planar side 20c of the receptacle 20 that extends perpendicular to the first and second planar sides 20a, 20b. In the example illustrated, the second outlet 28 has a generally circular shape and has a fluid flow area that is greater than fluid flow areas of the inlet 24 and the first outlet 26. In one example, the fluid flow area of the second outlet 28 is at least two in a half (2.5) times greater than the fluid flow areas of the inlet 24 and the first outlet 26. The velocity and/or pressure of fluid flowing through the second outlet 28 may be adjusted by a fluid control device. In the example illustrated, the fluid control device is an engine pump.

The receptacle 20 further comprises a first connecting member 30 located at the inlet 24 and a second connecting member 32 located at the first outlet 26. In this way, the conduits 19 can fluidly connect two or more firefighting apparatuses 18 to each other. In one example, the conduits 19 are threadably engaged to the first connecting member 30 and/or the second connecting member 32. In another example, the second connecting member 32 located at the first outlet 26 can be capped off such that fluid is inhibited from flowing through the first outlet 26.

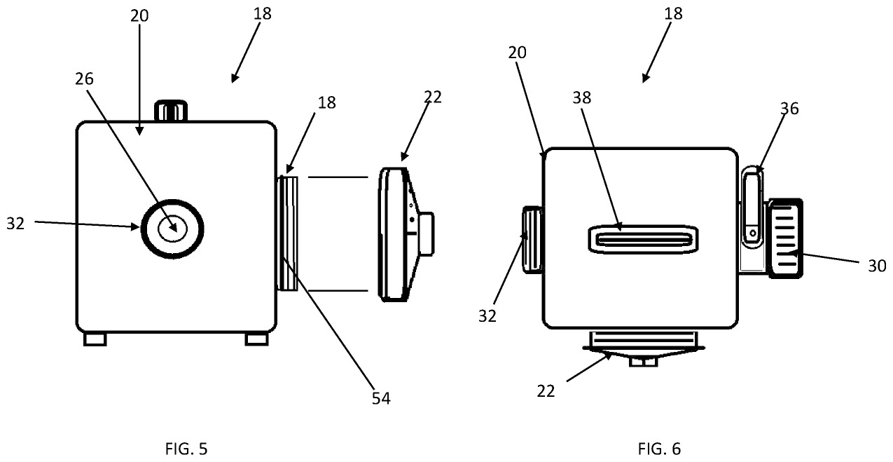

As shown in FIGS. 3a, 3b, and 6, a valve 36 is associated with the inlet 24 and is moveable between a first position in which pressurized fluid flowing from the pumping device 16 is allowed to flow through the inlet 24, and a second position in which pressurized fluid flowing from the pumping device 16 is inhibited from flowing through the inlet 24. In one example, the valve 36 is a ballcock valve. A handle 38 is secured to a top side of the receptacle 20 and is configured to facilitate moving the firefighting apparatus 18 from one location to another location. In the example illustrated, gripping elements 40 are secured to bottom corners of the receptacle 20 to facilitate steadiness of the firefighting apparatus 18. In one example, the gripping elements 40 are made of a rubber material.

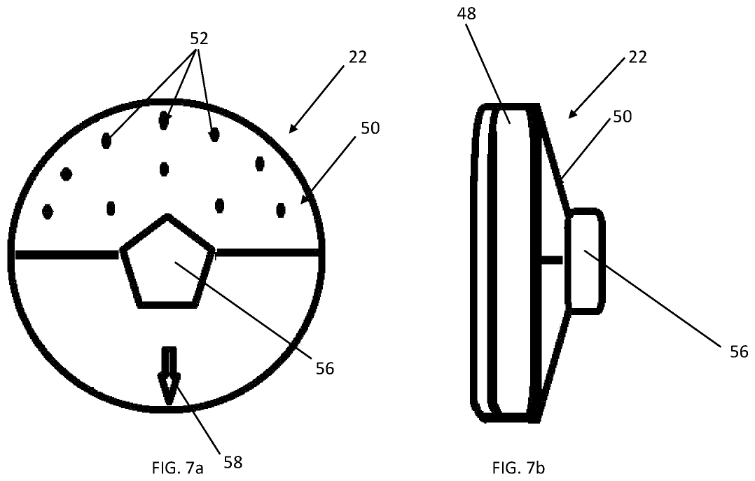

With reference to FIGS. 3a and 4-9, the fluid discharge cap 22 is removably secured to the receptacle 20 such that the fluid discharge cap 22 covers the second outlet 28. When the valve 36 is in the open position, pressurized fluid is allowed to flow through the receptacle 20 where it exits the fluid discharge cap 22 in a predetermined direction towards the fire. In the example illustrated, the fluid discharge cap 22 is a circular shape. In some configurations, the fluid discharge cap 22 can be other suitable shapes such as a rectangular shape or a triangular shape, for example. The fluid discharge cap 22 comprises a flange portion 48 (FIG. 7), a face portion 50, and a plurality of ports 52. The flange portion 48 extends around a periphery of the face portion 50 and includes internal threads that are engaged to external threads of a flange 54 (FIG. 5) of the receptacle 20. In this way, the fluid discharge cap 22 is interchangeable.

In the example illustrated, the face portion 50 has a wedge shape and spans an area of the second outlet 28. A cap detachment feature 56 is fixed to the face portion 50 at or near a central portion, and is configured to facilitate securement of the fluid discharge cap 22 onto the receptacle 20 and removal of the fluid discharge cap 22 from the receptacle 20. That is, a user secures a tool (not shown) to the cap detachment feature 56 and turns the tool to secure the cap 22 to the receptacle 20 or remove the cap 22 from the receptacle 20. In the example illustrated, the cap detachment feature 56 has a pentagonal shape. In some configurations, the cap detachment feature 56 may have a square hexagonal, or heptagonal shape, for example, to facilitate securement of the fluid discharge cap 22 onto the receptacle 20 and removal of the fluid discharge cap 22 from the receptacle 20.

A cap alignment feature 58 is associated with the face portion 50 and is configured to provide alignment of the fluid discharge cap 22 onto the receptacle 20. In the example illustrated, the cap alignment feature 58 comprises indicia such as an arrow that is located on the face portion 50, for example, to facilitate a user securing and aligning the cap 22 onto the receptacle 20. Such indicia can be printed or stamped onto the face portion 50. In some forms, indica may also be located on the receptacle 20 to further facilitate a user securing and aligning the cap 22 onto the receptacle 20.

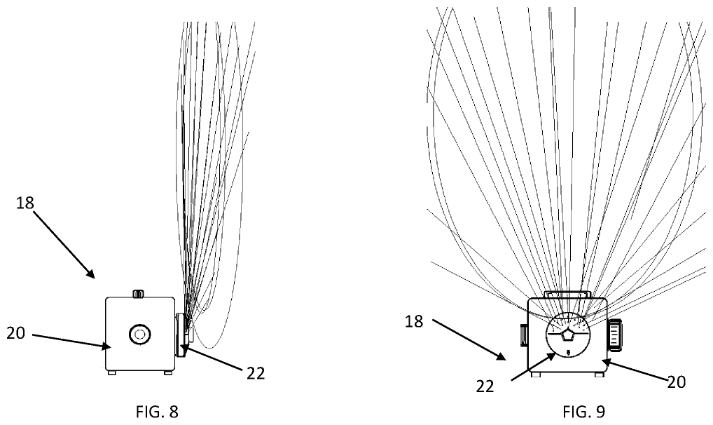

The plurality of ports 52 are formed in at least a portion of the face portion 50 and are configured to direct the pressurized fluid in a predetermined direction. In the example illustrated, the ports 52 are formed in an upper half of the face portion 50 and are configured to direct the pressurized fluid in a vertical direction (FIGS. 8 and 9). In some configurations, the ports 52 are formed across the entire face portion and are configured to direct the pressurized fluid in a horizontal direction or in a vertical direction. In other configurations, a first set of ports formed in a lower half of the face portion 50 are configured to direct the pressurized fluid in a horizontal direction and a second set of ports formed in an upper half of the face portion 50 are configured to direct the pressurized fluid in a vertical direction. In this way, the firefighting system 10 is used both as a fire containment unit and a fire extinguishing unit.

The firefighting system 10 of the present disclosure provides the benefit of containing and/or extinguishing fires in remote areas (e.g., remote homes and communities), for example, where fire hydrants connected to larger water sources are not common. For example, the firefighting system 10 of the present disclosure is operable to use water from a lake or pond, for example, to contain and/or extinguish a fire. One or more firefighting apparatuses 18 may be placed at the remote area for future use in an event of a fire. In this way, the firefighting system 10 of the present disclosure may be conveniently and quickly set up to contain or extinguish the fire.

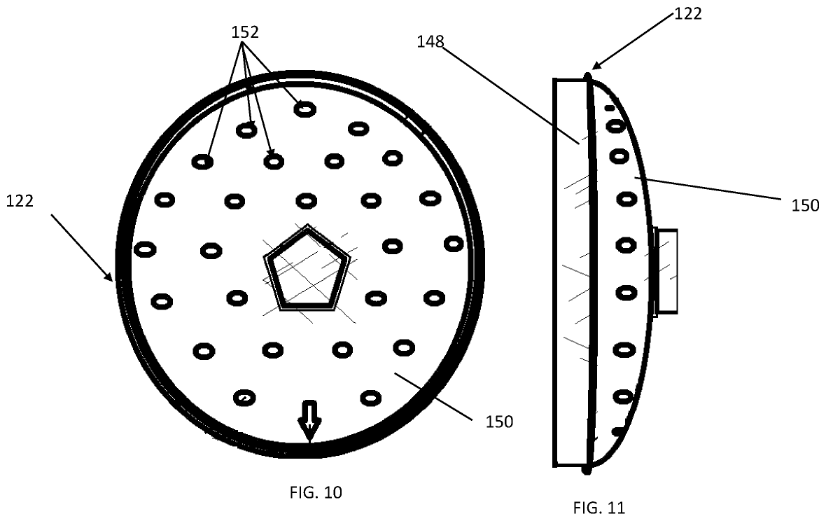

With reference to FIGS. 10-12, another fluid discharge cap 122 is illustrated. The fluid discharge cap 122 may be incorporated into the firefighting apparatuses 18 instead of the fluid discharge cap 22. The structure and function of the fluid discharge cap 122 is similar or identical to that of the fluid discharge cap 22 described above, apart from any exceptions noted below.

The fluid discharge cap 122 is removably secured to the receptacle 20 such that the fluid discharge cap 122 covers the second outlet. When the valve 36 is in the open position, pressurized fluid is allowed to flow through the receptacle 20 where it exits the fluid discharge cap 122 in a predetermined direction towards the fire. In the example illustrated, the fluid discharge cap 122 is a circular shape. The fluid discharge cap 122 comprises a flange portion 148, a face portion 150, and a plurality of ports 152. The flange portion 148 is similar or identical to the flange portion 48 described above, and therefore, will not be described again in detail.

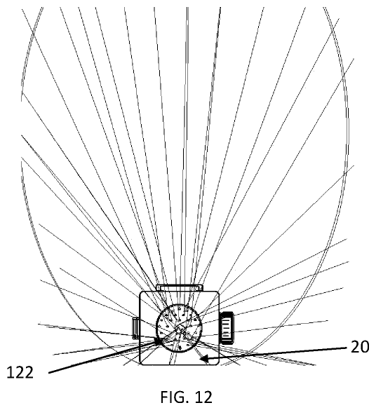

In the example illustrated, the face portion 150 has a dome shape and spans an area of the second outlet. The plurality of ports 152 are formed in at least a portion of the face portion 150 and are configured to direct the pressurized fluid in a predetermined direction. In the example illustrated, the ports 152 are formed across the entire face portion 150 and are configured to direct the pressurized fluid in a vertical direction (FIG. 12). In some forms, the ports 152 are configured to direct the pressurized fluid in multiple directions such as a vertical direction, a horizontal direction, a slanted direction or combinations thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A fluid discharge cap for a firefighting apparatus, the fluid discharge cap comprising:
a body configured to be removably secured to the firefighting apparatus and comprising a flange portion and a face portion, the flange portion extending around a periphery of the face portion and removably secured to the firefighting apparatus; and
a plurality of ports formed in at least a portion of the face portion of the body,
wherein pressurized fluid flowing through the firefighting apparatus exits the ports in a predetermined direction.

2. The fluid discharge cap of claim 1, further comprising a cap detachment member fixed to the face portion of the body, the cap detachment member configured to facilitate securement of the body onto the firefighting apparatus and facilitate removal of the body from the firefighting apparatus.

3. The fluid discharge cap of claim 2, wherein the cap detachment member has a pentagonal shape.

4. The fluid discharge cap of claim 1, further comprising a cap alignment feature associated with the face portion of the body and configured to provide alignment of the body onto the firefighting apparatus.

5. The fluid discharge cap of claim 1, wherein the face portion has a wedge shape or a dome shape.

6. The fluid discharge cap of claim 1, wherein the ports are configured to direct the pressurized fluid in a vertical direction.

7. A firefighting system comprising:
a first firefighting apparatus comprising:
a self-supporting receptacle including an inlet, a first outlet and a second outlet; and
a fluid discharge cap removably secured to the receptacle and covering the second outlet, the fluid discharge cap comprising a body comprising a flange portion, a face portion and a plurality of ports, the flange portion extending around a periphery of the face portion, the plurality of ports formed in at least a portion of the face portion of the body,
wherein pressurized fluid flowing through the receptacle exits the ports in a predetermined direction.

8. The firefighting system of claim 7, wherein the receptacle incudes a first connecting member located at the inlet of the receptacle and a second connecting member located at the first outlet of the receptacle.

9. The firefighting system of claim 8, further comprising a second firefighting apparatus fluidly connected to the first firefighting apparatus via the first connecting member or the second connecting member.

10. The firefighting system of claim 8, further comprising a valve associated with the inlet and moveable between a first position in which pressurized fluid is allowed to flow through the inlet of the receptacle and a second position in which pressurized fluid is inhibited from flowing through the inlet of the receptacle.

11. The firefighting system of claim 8, wherein the second outlet has a fluid flow area that is greater than the fluid flow areas of the inlet and the first outlet.

12. The firefighting system of claim 7, wherein the ports are configured to direct the pressurized fluid in multiple directions.

13. The firefighting system of claim 7, wherein the fluid discharge cap comprises a cap alignment feature associated with the face portion of the body and configured to provide alignment of the fluid discharge cap onto the receptacle.

14. The firefighting system of claim 7, wherein the face portion has a wedge shape or a dome shape.

15. The firefighting system of claim 7, wherein the first firefighting apparatus is portable.

16. A firefighting system comprising:
a plurality of firefighting apparatuses connected in series, each of the firefighting apparatuses comprising:
a receptacle including an inlet, a first outlet and a second outlet; and
a fluid discharge cap removably secured to the receptacle and covering the second outlet, the fluid discharge cap comprising a body comprising a flange portion, a face portion and a plurality of ports, the flange portion extending around a periphery of the face portion, the plurality of ports formed in at least a portion of the face portion of the body,
wherein pressurized fluid flowing through the receptacles exits the ports of the fluid discharge caps and forms a fluid curtain.

17. The firefighting system of claim 16, wherein each of the firefighting apparatuses are self-supporting.

18. The firefighting system of claim 16, wherein the plurality of firefighting apparatuses are portable.

19. The firefighting system of claim 16, wherein the plurality of firefighting apparatuses are connected in series via flexible conduits.

20. The firefighting system of claim 16, wherein the ports of the plurality of firefighting apparatuses are configured to direct the pressurized fluid in multiple directions.
